(19) United States
(12) Patent Application Publication
(10) Pub. No.: US 2003/0098920 A1
(43) Pub. Date: May 29, 2003

(54) Optical system and method for image capturing

(76) Inventor: Jer-Chuan Huang, Taipei (TW)

Correspondence Address: Keith Kline, PRO-TECHTOR INTERNATIONAL SERVICES, 20775 Norada Court, Saratoga, CA, 95070-3018, US

(21) Appl. No.: 10/017,845

(22) Filed: Nov. 29, 2001

(51) Int. Cl. H04N 5/225

(52) U.S. Cl. 348/335

(57) ABSTRACT

The invention provides an optical system and the method thereof for the image capture. The optical system of the invention comprises a special optical component, an aperture, second lens, a uniform light source and a detector. The special optical component further consists of a first lens and a triangular prism as a whole. The second lens is for further modifying and converging image generated through the special optical component while the detector such as a CMOS sensor is to receive the final image. Furthermore, an aperture is put between the special optical component and the second lens in order to reduce the aberration of the image generated through the special optical component. In addition, the present invention also uses two pairs of LEDs, with a specified position and brightness, instead of a pair of LEDs to generate a uniform light Source.

### BACKGROUND OF THE INVENTION

1. Field of the Invention

The present invention relates to an optical image capturing system and the method thereof, and comprises a special optical component, an aperture, an aspheric lens, a uniform light source and a detector.

2. Description of the Related Art

The technology of the biometrics becomes more and more no important in many fields such as anti-terrorism and information security. The principle of the systems and methods of these technologies are highly related to the quality of the input source image. For integration flexibility and wide acceptance of the market, the volume and the cost of the system must also be a big issue.

However, most of the prior art systems often have a relatively larger volume and higher price. In addition, those systems also give an image of low quality due to lower resolution or less contrast or non-uniform light source or high distortion.

The prior art systems and methods often capture the image through two lenses, a first lens and a second lens, and one prism, which will make these systems a larger volume and higher cost. Each system often comprises a light source generating light beams from one side of the prism. And the sampling object is placed on the other side of the prism. Thus, the light reflects from the sampling object, modified and converged by the first aspheric lens, and then further modified and converged by the second aspheric lens. The image of the sampling object will finally be imaged on a detector. However, these prior art systems and methods often have two defects: one is that the systems will have larger volume due to a longer optical path as mentioned above, so the system can not be easily integrated in the kinds of portable apparatus such as POS and PDA. On the other hand, the prior art systems often use two LEDs as the light source, which will make the light beams non-uniform. Therefore, a worse sampling image of the sampling object will thus be generated.

The purpose of the present art systems and methods are to overcome the drawbacks mentioned above, i.e. capture an image of good-enough quality from the objects, such as fingerprints with a smaller volume and a lower cost.

### SUMMARY OF THE INVENTION

One main objective of the present invention is to combine a prism and an aspheric lens as one special optical component in order to reduce the optical path of the invention and thus reduce the cost and improve the ease of production. In addition, the image quality will persist in high resolution (500 DPI), high contrast (MTF >0.3) and low distortion (less than 2%).

Another main objective of the present invention is to use two pairs of LEDs, with a specified position and brightness, instead of a pair of LEDs in order to generate uniform light source.

The invention mentioned above will thus solve the problems of light non-uniformity and the long optical path and complexity of production.

According to the above-mentioned objectives of the invention, the invention system is comprised of a special optical component, an aperture, an aspheric lens, a uniform light source and a detector.

The special optical component consists of a first aspheric lens and a triangular prism as a whole. The second lens is for further modifying and converging the image generated from the special optical component and the detector such as a CMOS sensor is to receive the final image. Furthermore, an aperture is put between the special optical component and the second lens in order to reduce the aberration of the image generated from the special optical component.

The light beam, generated from two pairs of LEDs, will be incident from the flat side of the prism of the special optical component, and reflects from the object side to the first lens of the special optical component. The first lens of the special optical component will then modify and converge the received light beam. The light beam, through the aperture, reaches the second lens and then generates the corresponding image of the object on the detector such as a CMOS sensor.

According to the optical system of the invention herein, we further disclose a method depending on the optical system of the invention. The method consists of the following steps:

(a) Use a special optical component, which is a combination of a prism and an aspheric lens, instead of the prior separated prism and lens.

(b) Install the light source such as two pairs of LEDs at the triangular prism side of the special optical component. The position and brightness of the LEDs are well defined.

(c) Install a detector such as a CMOS sensor at the first lens side of the special optical component.

(d) Install the second lens between the special optical component and the detector.

(e) Install the aperture between the special optical component and the second lens.

### BRIEF DESCRIPTION OF DRAWINGS

The following detailed description, given by way of examples and not intended to limit the invention to the embodiments described herein, will best be understood in conjunction with the accompanying drawings, in which:

FIG. 1 illustrates the optical system of this invention;

FIG. 2 illustrates the optical system of this invention with the collimated light beam;

FIG. 3 illustrates a uniform light source; and

FIG. 4 illustrates a flow chart of the invention.

### DETAILED DESCRIPTION OF THE INVENTION

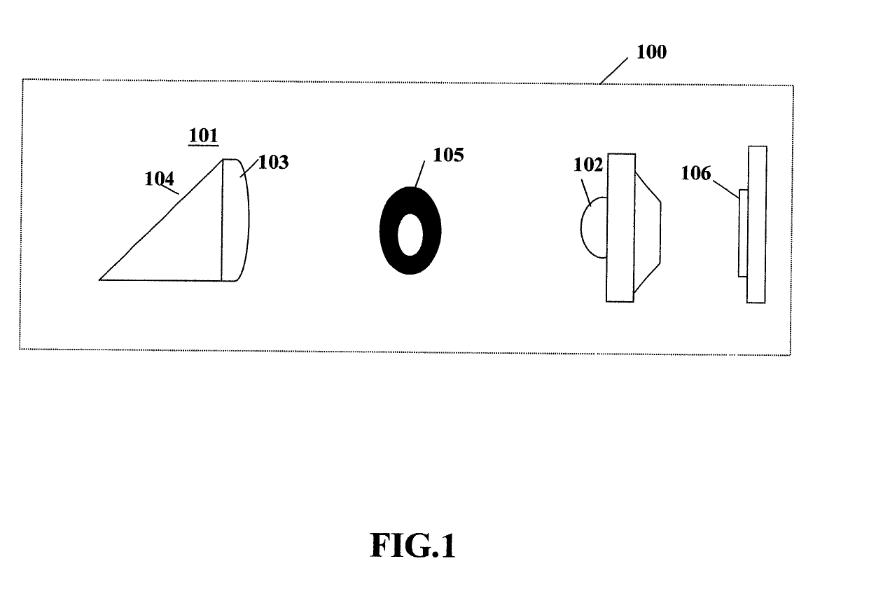

Referring to FIG. 1, the FIG. 1 illustrates the optical system 100 of the invention. Within the figure, there are a special optical component 101 and an aspheric lens 102. The special optical component 101 further consists of a first lens 103 and a triangular prism 104 as a whole. The second lens 102, is for further modifying and converging the image generated through the special optical component 101. Furthermore, an aperture 105 is put between the special optical component 101 and the second lens 102 in order to reduce the aberration of the image generated through the special optical component 101. A detector 106 such as a CMOS sensor 106, is to receive the final image from the second lens.

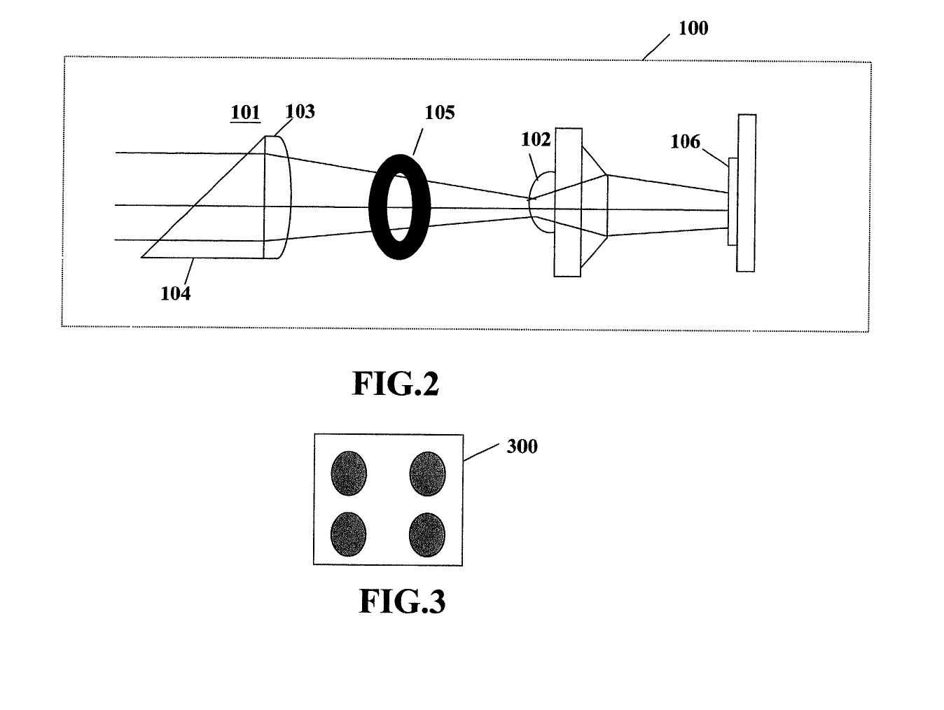

As show in the FIG. 2, the FIG. 2 illustrates the optical system 100 of the invention with the collimated light beam such as two pairs of LEDs 300 as shown in FIG. 3. The special optical component 101 herein is equivalent to a prism in combination with a Plano-convex lens as a first lens 103. The collimated light beams are generated from the two pairs of LEDs 300 and beamed into the special optical component 101. The special optical component 101 receives the collimated light beams and then reflects from the object side to the first lens 103. The first lens 103 will then modify and converge the collimated light beams reflected from the prism 104 of the special optical component 101. Finally, the collimated light beams, through the aperture 105, reaches the second lens 102 and generates the image on a detector 106 such as a CMOS sensor 106.

FIG. 3 illustrates a uniform light source, which do solve the problem of non-uniform light source by means of the radiation emitted from two pairs of LEDs 300 as shown in the FIG. 3, installed in the side of the lateral edge of the lens-prism component.

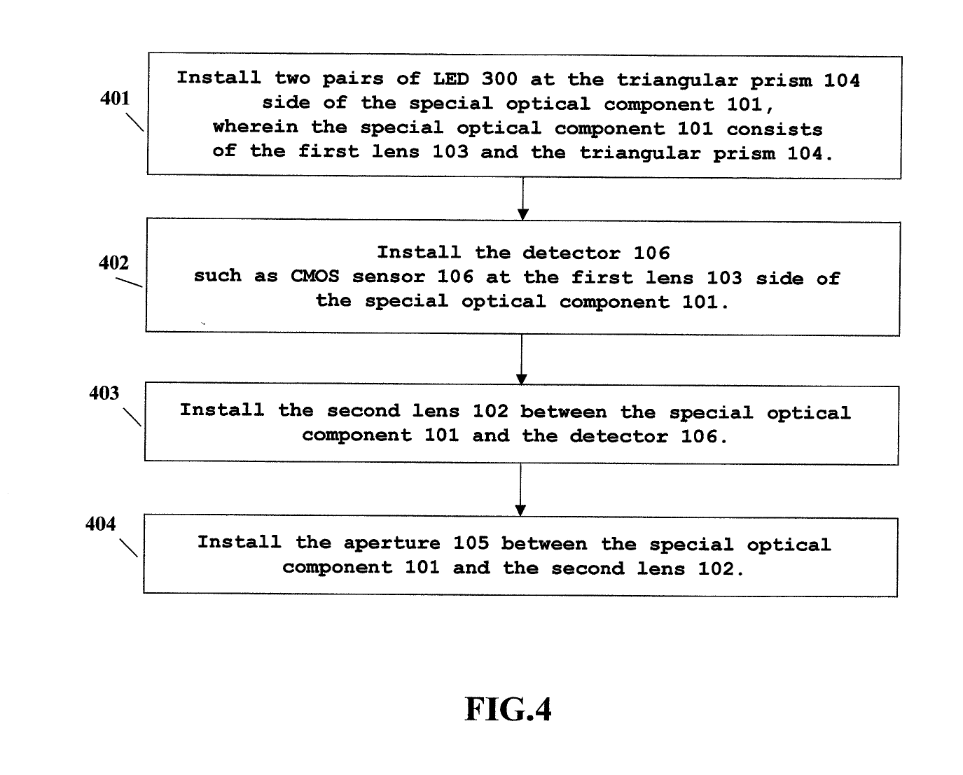

According to the optical system of the invention herein, FIG. 4 further disclose a flow chart 400 of the invention. The method comprises following steps:

Step 401: Install a light source such as two pairs of LEDs 300 at the triangular prism 104 side of the special optical component 101, wherein the special optical component 101 consists of the first lens 103 and the triangular prism 104;

Step 402: Install a detector such as a CMOS sensor 106 at the first lens side of the special optical component 101.

Step 403: Install the second lens 102 between the special optical component 101 and the detector.

Step 404: Install the aperture 105 between the special optical component 101 and the second lens 102.

The foregoing method is not limited in its steps order. That is, we also can first do the step 403 or 402, and then make any the other steps such as 401, 402 or 403 in turn.

While the invention has been described with reference to various illustrative embodiments, the description is not intended to be constructed in a limited sense. Various modifications of the illustrative embodiments, as well as other embodiments of the inventions will be apparent to those persons skilled in the art upon reference to this description. It is therefore contemplated that the appended claims will cover any such modifications or embodiments as may fall within the scope of the invention defined by the following claims and their equivalents.

What is claimed is:

1. A optical system for image capturing, comprising
a special optical component consists of a first lens and a triangular prism as a whole;
a uniform light source;
a detector installed at the first lens side of said special optical component;
a second lens installed between said special optical component and said detector; and
an aperture installed between said special optical component and said second lens.

2. The optical system of claim 1 wherein said uniform light source is at least two pairs of LEDs.

3. The optical system of claim 1 wherein said first lens is a Plano-convex lens.

4. The optical system of claim 1 wherein said detector is a CMOS sensor.

5. A method for image capturing, comprising
Installing a uniform light source at the side of a triangular prism of a special optical component, wherein said special optical component consists of a first lens and said triangular prism;
Installing said detector at the side of said first lens of said special optical component;
Installing an second lens between said special optical component and said detector; and
Installing an aperture between said special optical component and said second lens.

6. The method of claim 5 wherein said uniform light source is at least two pairs of LEDs.

7. The method of claim 5 wherein said first lens is a Plano-convex lens.

8. The method of claim 5 wherein said detector is a CMOS sensor.
